(19) United States
(12) Patent Application Publication
(10) Pub. No.: US 2017/0346522 A1
(43) Pub. Date: Nov. 30, 2017

(54) QUICK RELEASE MOUNT FOR HOLDING HANDHELD ELECTRONIC DEVICE

(71) Applicant: Gwo-Jye YAN, Taipei City (TW)

(72) Inventor: Gwo-Jye YAN, Taipei City (TW)

(21) Appl. No.: 15/464,614

(22) Filed: Mar. 21, 2017

(30) Foreign Application Priority Data
May 27, 2016 (TW) 105116636

(51) Int. Cl. H04B 1/3877; H04B 5/00

(52) U.S. Cl. CPC H04B 1/3877; H04B 5/0075; H04B 5/0031; H04B 5/0037; H04B 5/0062

(57) ABSTRACT

The present invention is to provide a quick release mount for holding handheld electronic device, comprises a mount base having an accommodating space inside, and a base hole on topside thereof; a constraint sliding plate movablely installed inside the accommodating space, having an upper side provided with a plate hole, a push button disposed on one end thereof, and having a free end exposed outside the mount base, when the push button is pushed, the stud element protruding on rear side of the handheld electronic device can pass through base and plate holes and freely access the accommodating space; and an resilient element abutted against the mount base and the constraint sliding plate, so that, when the push button is released, the resilient element can force the constraint sliding plate to move to a lock state not allowing the stud element to escape from the plate hole.

### FIELD OF THE INVENTION

The present invention generally relates to a quick release mount, more particularly to a quick release mount capable of holding handheld electronic device, not only enabling the handheld electronic device to be quickly and stably hanged before a user's chest, but also enabling the handheld device to be securely positioned and resting on a user's personal belongings (such as a belt, a handle of a handbag) or to be installed on the objects (such as a cradle head of a conventional tripod, a supporting rod for a car, a handle of a bicycle or a motorcycle, etc.) within a sight visible range and not easy to be lost. Thus, in case both hands of the user are doing work and unavailable to hold the handheld electronic device, the user is still able to read the information or instant message from the handheld device.

### BACKGROUND OF THE INVENTION

In recent years, due to the rapid development of electronic and telecommunication technologies, the handheld electronic devices (such as mobile phone, smart phone, . . . etc.) not only have powerful telecommunication functions, but also provide a variety of practical applications (such as noting, timing, counting, scheduling, lighting, photographing, video or voice recording, GPS, mapping, statistics, conference, investment, withdrawing money from bank, shopping, booking, making reservation, chatting, social networking, playing games, . . . etc.) to meet with people's daily life, work, social and other entertainment needs. That is also the reason why the mobile phones are now becoming one of the most indispensable and important belongings to most people, especially those who living in the metropolitan areas. Almost every people always having a mobile phone on hand is also now becoming a very common scene everywhere in the metropolitan areas. Hereby taking the following iPhone Series mobile phone designed, manufactured and sold by Apple Computer, Inc. U.S.A. as examples for analyzing the reasons behind:

(1) iPhone officially launched at the date of Jun. 29, 2007 with a dimension of which the length, width and thickness are 115 mm, 61 mm and 11.6 mm, respectively;

(2) iPhone 3G officially launched at the date of Jul. 11, 2008 with a dimension of which the length, width and thickness are 115.5 mm, 62.1 mm and 12.3 mm, respectively;

(3) iPhone 4 officially launched at the date of Jun. 24, 2010 with a dimension of which the length, width and thickness are 115.2 mm, 58.6 mm and 9.3 mm, respectively;

(4) iPhone 5 officially launched at the date of Sep. 21, 2012 with a dimension of which the length, width and thickness are 123.8 mm, 58.6 mm and 7.6 mm, respectively;

(5) iPhone 6 officially launched at the date of Sep. 19, 2014 with a dimension of which the length, width and thickness are 138.1 mm, 67.0 mm and 6.9 mm, respectively; and

(6) iPhone 6 Plus officially launched at the date of Sep. 9, 2015 with a dimension of which the length, width and thickness are 158.1 mm, 77.8 mm and 7.1 mm, respectively.

In view of the above, in sequence to satisfy the irreversible inclination that people must frequently use their mobile phones in their daily lives, the designs of iPhone series have been significantly transformed from the past compact dimension (the first-generation iPhone's length×width×thickness is 115×61×11.6 mm3) to a larger but thinner dimension (the latest generation iPhone 6 Plus's length×width×thickness is now 158.1×77.8×7.1 mm3), so as to let people more easily and readily hold their mobile phones on hand as well as more easily and clearly browse websites and view information or instant message displayed on the big screen thereof. This dimensional inclination has also driven other mobile phone designing and manufacturing companies in the world to follow thereafter, so that the slim body with big screen has now become a mainstream of the smartphones and also causes the new generation of smartphones now no longer suitable for being put into pocket of a user's cloth or pants as the old compact mobile phones used to be. It's no wonder that almost every people always having a smartphone on hand is now a very common scene everywhere in streets of metropolitan areas all over the world. Though, holding a smartphone on hand seems inexplicably to satisfy many people's needs, however, when using the smartphone with a slim body and a big screen on hand, people often have to encounter the following inconveniences and problems:

(1) Walking in metropolitan area in sunshiny days, when holding a smartphone on hand and making a phone call or browsing websites, often resulting in accidentally hitting other people or object on the road due to excessively focusing on calling or browsing or in a hurry action, causing the smartphone thrown away from hand and falling to ground, and seriously damaging the smartphone or the display screen thereof, sometimes, even completely destroying the smartphone due to a vehicle (such as wagon, bicycle, motorcycle or car . . . etc.) passing by. Under this circumstance, in addition to heartbreaking pain for the loss of all files and information stored in the smartphone, the user is also unable to request the innocent people passing by for the damage of the smartphone.

(2) In rainy days, walking in the metropolitan area with one hand holding an umbrella and the other hand carrying a briefcase or bag, when hearing phone rings from a smartphone placed in the pocket of cloth or pants and scrambling to take the smartphone out from the pocket, the smartphone is inadvertently slipping off the hand and falling into a puddle on the street, causing the smartphone unable to be used due to a short circuit. Under this circumstance, in addition to the heartbreaking pain for losing all precious files and information stored in the smartphone, the user can only complain to the God.

(3) Standing in public transportation (such as bus, train or MRT), with one hand grasping a hanging handle or handrail and the other hand holding a smartphone and browsing web sites or having a phone call, it is often that, due to a sudden shaking of the public transportation or collisions by the hurrying on and off passengers, accidentally causing the smartphone thrown away from the hand and heavily falling to the ground, causing serious damages to the smartphone or the display screen thereof, and even completely destroying the smartphone after it has been trampled by the hurrying on and off passengers passing by. Under this circumstance, in addition to the heartbreaking pain for losing the precious files and information stored in the smartphone, there is no recourse can be requested for compensation.

(4) Taking pictures or recording videos through using a smartphone while travelling without carrying a bracket or tripod, people would always like to use the materials available at hand, such as using a backpack, carrying bag, twigs or stones, etc., for supporting the rear side of the smartphone placed on a corresponding high place, and then adjusting the shooting or video angle of the smartphone, however, since the materials available at hand are often unable to provide enough friction for stably positioning the smartphone due to the flat and silky rear plane of the smartphone, which eventually causes the smartphone easily fallen from the high place and heavily hitting the ground while in operation and then seriously damages the smartphone or the display screen thereof. Under this circumstance, in addition to the heartbreaking pain for losing the precious files and information stored in the smartphone, also losing the happiness and interest in the subsequent traveling.

(5) The incidents happening in our daily lives similar to the aforementioned circumstances are abundant and hard to be detailedly described here, however, according to statistics, most people often encountered circumstances of losing their smartphones in public places (such as restaurants, stores, playgrounds or libraries . . . etc.). In general, most people often like to temporarily put their smartphones on seats, desktops or countertops in public places after using their smartphones and, then suddenly thinking of doing something (such as taking food, inquiring price, replacing something, finding book or going to the toilet, . . . etc.) and unwittingly forgetting the smartphones on the seats, desktops or countertops due to their ultra-thin and flat dimensions and extremely not eye-catching configurations, especially when being flat on the seats, desktops or countertops. While recalling their memories and returning back to the lost locations, their smartphones had already been taken by malicious persons around. Under these circumstances, not only the chances for regaining their smartphones back are very slim, but also the personal and private files and information stored therein were likely to be stolen or opened to the public, which are sometimes causing unexpected damages to the owners of the smartphones far more seriously than the smartphones themselves.

(6) Also, in recent years, due to a variety brands of smartphones continue to introduce new and latest smartphones in the market with the dimensions slightly different from the previous generation. Every time when a user purchased a latest type of smartphone and wishes to use the new smartphone in executing photographing, recording video, traffic recording or global positioning (GPS) . . . and other functions, the user must re-purchases a dedicated tripod, bracket or mounting device having the same specification exclusively for the new smartphone, otherwise, the new smartphone can't be attached to a bicycle's or motorcycle's handlebar or the interior of a car, which not only led the previously purchased tripod, bracket or mounting device unable to be used again, but also led the previously purchased tripod, bracket or mounting device being discarded eventually, resulting in a tremendous waste of resources that obviously and seriously violates the callings of cherishing resources, saving energy and reducing carbon dioxide being repeatedly demanded by the world organizations within the past several decades.

Accordingly, how to design a quick release mount for holding handheld electronic device so that the handheld electronic device can be quickly and stably hanged before the user's chest through at least a stud element, so as to effectively prevent the handheld electronic device from being lost unexpectedly; and how to design a quick release mount for holding handheld electronic device so that the handheld electronic device can also be quickly and securely resting on a user's personal belongings (such as a belt, a handle of a handbag) or to be installed on the objects (such as a cradle head of a conventional tripod, a supporting rod for a car, a handle of a bicycle or a motorcycle, etc.), when the user is unable to hold the handheld electronic device on hand, the handheld electronic device can still be securely positioned within a hand reachable and sight visible position; which are the important issues going to be discussed hereinafter by the present invention.

### BRIEF SUMMARY OF THE INVENTION

It is an objective of the present invention to provide a quick release mount capable of holding handheld electronic device. The quick release mount can not only be fastened to the user's chest by means of at least one stud element protruding from the rear side of the handheld electronic device and integrated with the handheld electronic device, but also can be fastened to other objects such as a belt, carrying handle on the table or platform, or securely positioned on the desktop of a user's home, workplace or public place (such as a restaurant, store, playground, or library . . . ), so that the handheld electronic device is not easy to lose. In addition, in case when both hands of the user are doing work and in a state unavailable to hold the handheld electronic device, the user is still able to read information or instant message displayed on the handheld electronic device stably positioned on the quick release mount within a hand reachable and a sight visible range. In addition, the quick release mount can further be installed on a conventional tripod, or a supporting rod for a car, a handle of a bicycle or a motorcycle, etc.) within a sight visible range for the user to stably carry out lighting, photographing, traffic recording, travel recording or global positioning (GPS) . . . and other functions.

Another objective of the present invention is that the stud element can displaced toward the quick release mount while the stud element of the handheld electronic device is inserted into the quick release mount so that the rear side of the handheld electronic device adjacent to the center of gravity can be secured to the front side of the quick release mount, so when the handheld electronic device is hanging before the user's chest, or positioning and resting on the object, the handheld electronic device is less prone to shaking for facilitating the user to clearly see the message displayed on the screen of the handheld electronic device, or perform other tasks through the screen of the handheld electronic device.

Yet another objective of the present invention is that the quick release mount further including a Near Field Communication (hereinafter referred to as NFC) or Radio Frequency Identification (hereinafter referred to as RFID) installed in the quick release mount when the stud element of the handheld electronic device is inserted into and secured to the quick release mount, the wireless communication circuit can be driven so that the handheld electronic device can receive an locking signal regularly issued by the wireless communication circuit. In this way, when the handheld electronic device is taken away from the quick release mount by others without having the permission and is unable to receive the locking signal within a predetermined period of time, the handheld electronic device will generate an alert signal (such as warning lights and/or warning sounds) to warn the owner of the handheld electronic device, so as to ensure that the handheld electronic device is not easily taken away by others.

### BRIEF DESCRIPTION OF THE DRAWINGS

The features, objectives and advantages in conjunction with the subject matters claimed in the present invention will be best understood by reference to the structures as well as the preferred embodiments clearly described and shown in the following detailed description and the accompanying drawings thereof:

FIG. 1 is a perspective view of a positioning structure for a handheld device;

FIG. 2 is an exploded view of a first preferred embodiment of the present invention;

FIG. 3 shows a quick release mount of FIG. 2 in an unlock state;

FIG. 4 shows the quick release mount of FIG. 2 in a lock state;

FIG. 5 is a cross section view of the quick release mount of FIG. 4 in a lock state;

FIG. 6 is an exploded view of another embodiment of the present invention;

FIG. 7 is an exploded view of a second preferred embodiment of the present invention;

FIG. 8 shows a quick release mount of FIG. 7 in an unlock state;

FIG. 9 shows the quick release mount of FIG. 7 in a lock state;

FIG. 10 is a perspective view of the quick release mount of the present invention;

FIG. 11 shows a use status of the quick release mount of the present invention;

FIG. 12 is a perspective view of other embodiment of the quick release mount of the present invention;

FIG. 13 is a perspective view of the other embodiment of the quick release mount of the present invention;

FIG. 14 is an exploded view of a third preferred embodiment of the present invention;

FIG. 15 is an exploded view of a pivot joint between an amount base and a support adapting rod of the present invention;

FIG. 16 is an exploded view of a pivot joint between the support rod and a positioning base of the present invention;

FIG. 17 is an exploded view of another embodiment of the support rod of the present invention;

FIG. 18 is an exploded view of a pivot joint between the support rod of FIG. 17 and the positioning base of the present invention;

FIG. 19 shows a use status of the quick release mount of the present invention;

FIG. 20 is a circuit diagram of the wireless communication circuit of a fourth preferred embodiment of the present invention in open-circuit status;

FIG. 21 is a circuit diagram of the wireless communication circuit of FIG. 20 in broken circuit status; and

FIG. 22 is a block diagram of a warning program of the present invention, wherein FIG. 22 is composed of FIG. 22A and FIG. 22B joined together by the connector A.

### DESCRIPTION OF THE EXEMPLARY EMBODIMENTS

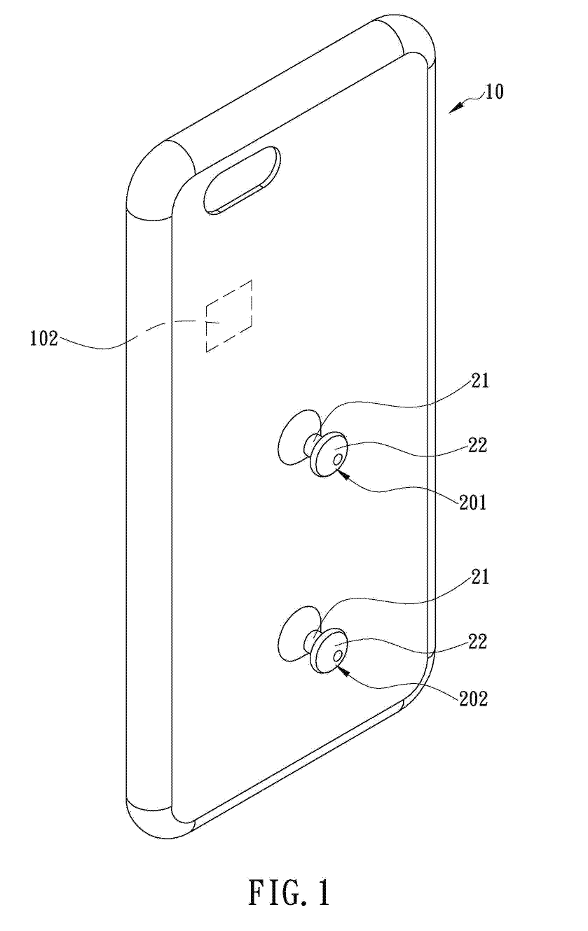

As mentioned above, the thinner body adapted for grip and the larger screen adapted for viewing have now become an irreversible design inclination of the mobile phone or smartphone. Accordingly, the bigger size of the mobile phone is in turn no longer suitable for being placed in pocket of user's cloth or pants, no wonder almost every person holding a bigger size mobile phone on hand is now naturally becoming an extraordinary scene everywhere in the metropolitan areas of the world. Due to the thinner structure of the mobile phone, the mobile phone is also unable to be installed an additional positioning structure therein, like the one installed on a conventional camera or camcorder for mounting the camera or camcorder to a cradle head of a conventional tripod. Considering the limited and narrow space in the thinner structure of the mobile phone, the inventor thinks of designing a minimized and simplified positioning structure to effectively solve the aforementioned inconveniences and problems which most users often encountered. Please refer to FIG. 1, the positioning structure comprises a case, a first stud element 201 and a second stud element 202, wherein the case can be a rear case of the handheld electronic device 10 or a protective case attached to and covering on the rear case of the handheld electronic device 10. In subsequent description of the present invention, the handheld electronic device is also marked as “10” on behalf of the case for convenience in describing the features of the present invention. Again referring to FIG. 1, the first stud element 201 and the second stud element 202 are directly protruding from the rear side of the handheld electronic device 10 at the positions adjacent to the central position and the side edge thereof, respectively, each of the first stud element 201 and the second stud element 202 further includes a stud pillar 21 and a stud head 22, wherein an end of the stud pillar 21 is fixed to the handheld electronic device 10, the other end of the stud pillar 21 is connected to one end of the stud head 22, and maximum cross section of the stud head 22 is larger than cross section of the stud pillar 21.

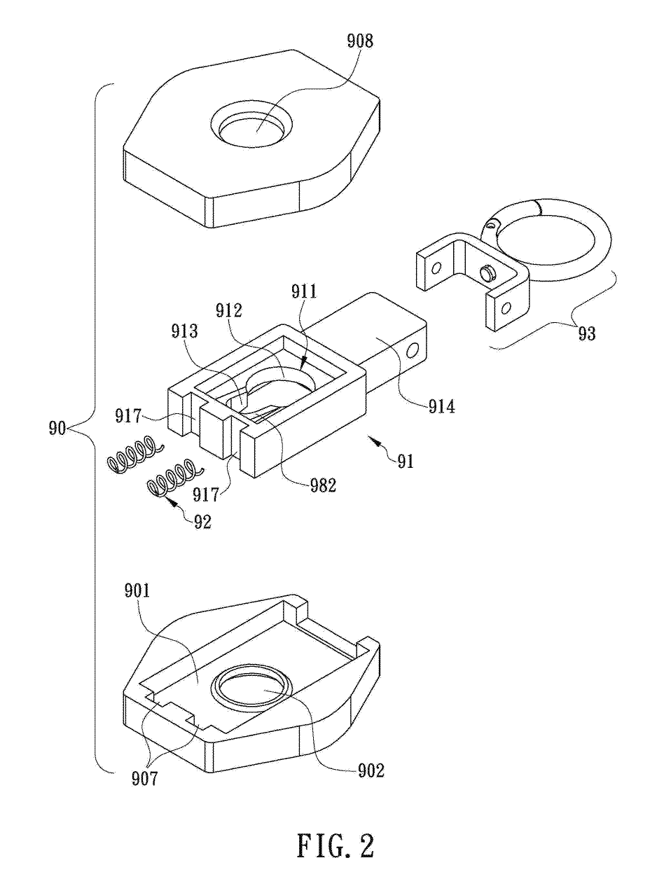

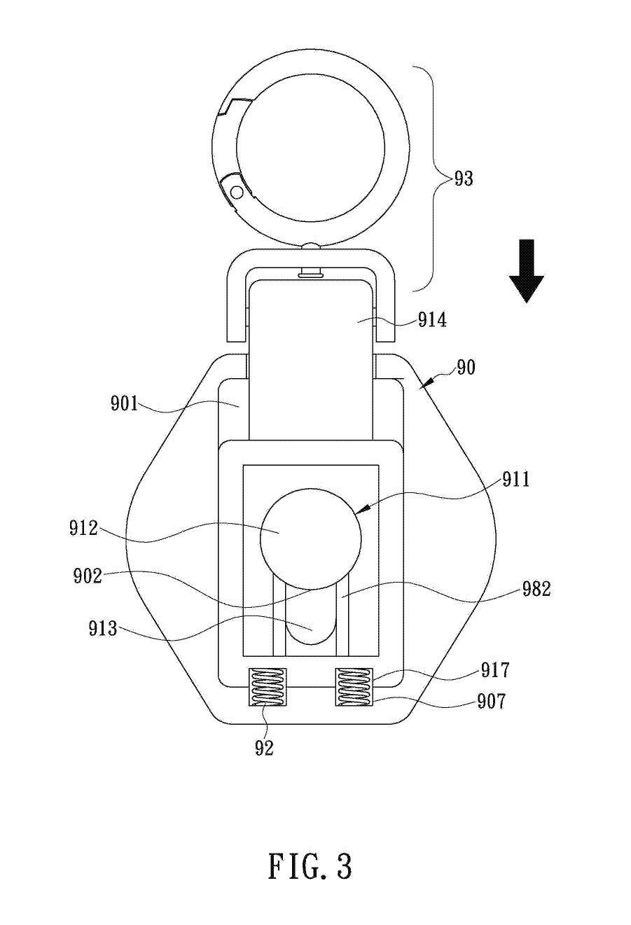

Accordingly, in order to enhance the effort of the above-mentioned positioning structure of the handheld device 10, the inventor hereby designs a quick release mount of the present invention not only enabling the handheld electronic device 10 to be quickly and stably hanged before a user's chest, but also enabling the handheld device 10 to be securely positioned and resting on a user's personal belongings (such as a belt, a handle of a handbag) within a sight visible range and not easy to be lost. Thus, in case both hands of the user are doing work and unavailable to hold the handheld electronic device 10, the user is still able to read the information or instant message from the handheld device 10. Please refer to FIG. 2, in the first preferred embodiment of the present invention, the quick release mount comprises a mount base 90, a constraint sliding plate 91, and at least a resilient element 92. In subsequent description of the present invention, on behalf of the case for convenience in describing the features of the present invention, the bottom side of the mount base 90 is regarded as the front side of the mount base 90, and the upper side of the mount base 90 is regarded as the rear side of the mount base 90, wherein the mount base 90 includes an accommodating space 901, and a base hole 902 is disposed on the front side thereof, wherein the base hole 902 is in communication with the accommodating space 901, and the aperture of the base hole 902 is larger than the maximum diameter of the stud Head 22 so that the stud head 22 can pass through the base hole 902 and enter into the accommodating space 901; the constraint sliding plate 91 is movably mounted within the accommodating space 901, the constraint sliding plate 91 has a plate hole 911 disposed thereon, the plate hole 911 includes a release hole 912 and a engaging groove 913 in communication with the release hole 912, and the release hole 912 is larger than the maximum diameter of the stud head 22. The groove width of the engaging groove 913 is smaller than the maximum diameter of the stud head 22, but larger than the maximum diameter of the stud pillar 21. A push button 914 is protruded at one end of the constraint sliding plate 91, and the free end of the push button 914 is exposed outside one end of the mount base 90 as shown in FIG. 3. Please again refer to FIG. 3. In the state that the push button 914 is being pressed, the other end of the constraint sliding plate 91 can be displaced (in the direction of the arrow) for enabling the base hole 902 to be moved to a position corresponding to the release hole 912, so that the stud head 22 can pass freely through the base hole 902 and the release hole 912 and into and out of the accommodating space 901 and thereby becoming in an unlock state.

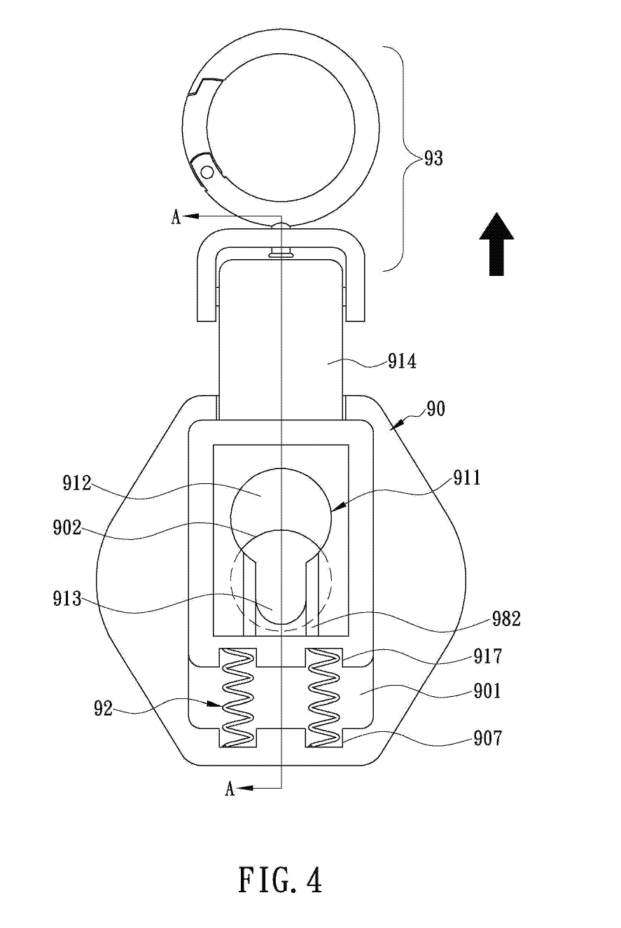

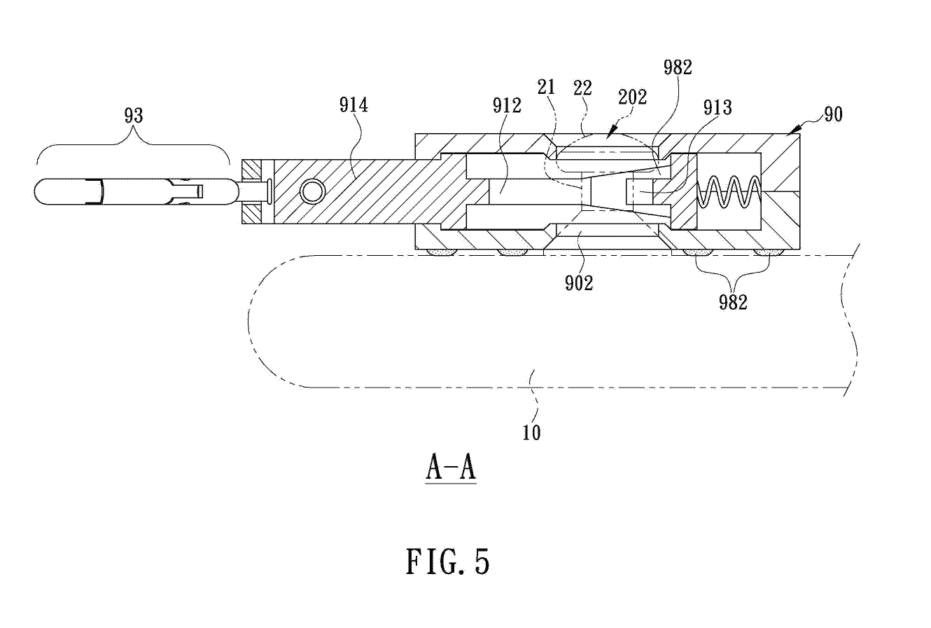

Please again refer to FIG. 2. One end of the resilient element 92 is abutted against the inner wall of the mount base 90 and the other end of the resilient element 92 is abutted against the other end of the constraint sliding plate 91. Please refer to FIG. 4. The constraint sliding plate 91 can be displaced (in the direction of the arrow) by the elastic force of the resilient element 92 for enabling the engaging groove 913 to be moved to a position corresponding to the base hole 902 while the push button 914 is being released and the stud pillar 21 is positioned in the engaging groove 913, so that the stud pillar 21 can be positioned and embedded in the engaging groove 913 while the stud head 22 has sequentially passed through the base hole 902 and release hole 912 and entered into the accommodating space 901, thereby the stud head 22 becoming in a lock state and unable to escape from the plate hole 911. In the preferred embodiment mentioned above, Please refer to FIGS. 2˜4. two positioning slots 917, 907 are provided on the constraint sliding plate 91 and the mount base 90 at the corresponding positions thereof respectively, so that the two ends of the resilient element 92 can be respectively positioned to the positioning slots 917, 907, wherein The slots 917, 907 may be a locating slot or a locating column, respectively. In the best preferred embodiment of the quick release mount of the present invention, the positioning slots 917 and 907 are a positioning groove. Thus, when the push button 914 is being pressed, please again refer to FIG. 3, the other end of the constraint sliding plate 91 is displaced to a position corresponding to the inner wall of the mount base 90, in the meanwhile, the release hole 912 can be moved to a position corresponding to the base hole 902 so that the resilient element 92 can be collapsed within the corresponding positioning slots 917, 907, respectively. Again Referring to FIGS. 2˜4, in the preferred embodiment of the present invention, the quick release mount further comprises at least an adapter 93 (e.g., hanging rings) which is provided at the free end of the push button 914 or the periphery of the mount base 90 for the user to suspend the quick release mount to one of the user's chest straps, Belt, carrying handle, backpack shoulder straps and other objects. Thus, please again refer to FIGS. 1˜4, when both hands are doing work and in a state unavailable to hold the handheld electronic device, the user only needs to insert the first stud element 201 or the second stud element 202 on the rear side of the handheld electronic device 10 into the mount base 90 sequentially through the base hole 902 and plate holes 911, the handheld electronic device 10 can be in a lock state. However, since the handheld electronic device 10 can be easily removed from the mount base 90, the user can easily remove the handheld electronic device 10 from the mount base 90 and use the handheld electronic device 10 at any time when needed. Please refer to FIG. 5. The quick release mount further contains a packing element 980 which is made of flexible materials, located in front of the mount base 90. Please again refer to FIGS. 2˜4. On the rear side of the constraint sliding plate 91, an abutment parts 982 are respectively provided on the sides corresponding to the engaging groove 913 along both sides of the engaging groove 913. The thickness of the abutment part 982 is larger than the thickness of the corresponding constraint sliding plate 91 and is gradually increased toward the direction away from the release hole 912. Thus, please again refer to FIG. 5, when the stud head 22 of the second stud element 202 is inserted into the rear side of the constraint sliding plate 91 after sequentially passing through the base hole 902 and the release hole 912 the stud pillar 21 can be embedded and fitted into the engaging groove 913, for enabling the stud head 22 to lean on and push against the abutment part 982 so that the packing element 90 of the front side of the mount base 90 can be firmly in contact against the rear side of the handheld electronic device 10 so that the handheld device 10 will not be rock on the mount base 90.

Again referring to FIG. 5, in another preferred embodiment of the present invention, the quick release mount can also be installed without having the packing element 90, only when the abutment part 982 formed on the constraint sliding plate 91 is made of an elastic material, such as: metal shrapnel, a flexible soft plastic (such as, thermoplastic polyurethane (Thermoplastic Polyurethane, TPU), or silicone), and the rear side surface of the handheld electronic device 10 adjacent to the center of gravity can be firmly in contact against the front side of the mount base 90 when the handheld electronic device 10 being in a lock state on the mount base 90.

In the above embodiment of the present invention, in order to make the thickness of the mount base 90 thinner, please again refer to FIGS. 1 and 2, the rear side of the mount base 90 is provided with a through hole 908 in communication with the accommodating space 901 at a position corresponding to the base hole 902, and the through hole 908 has a diameter greater than the maximum diameter of the stud head 22. Thus, please again refer to FIG. 5, when the stud head 22 has sequentially passed through the base hole 902 and release hole 912, and the stud pillar 21 can be positioned in the engaging groove 913 and embedded into the engaging groove 913 in a lock state, the free end of the stud head 22 is always able to pass through the through hole 908, and exposed on the rear side of the mount base 90, thereby substantially reducing the thickness of the mount base 90.

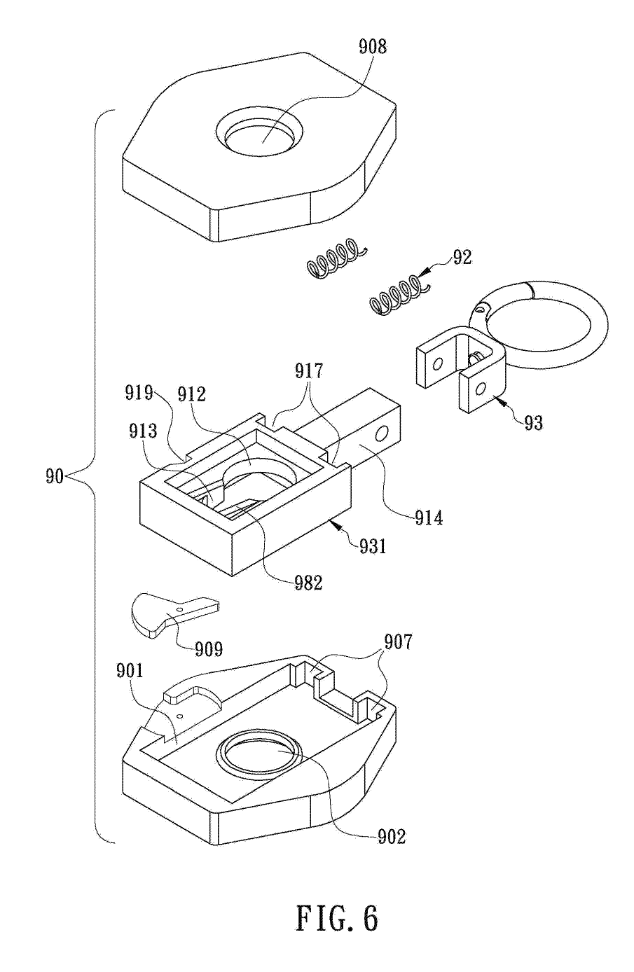

Please refer to FIG. 6, in the other preferred embodiment of the present invention, one end of the resilient element 92 is abutted against the inner wall of the mount base 90 and the other end of the resilient element 92 is abutted against the one end of the constraint sliding plate 91. A constraint key 909 is pressed against the constraint slot 919 provided in the constraint sliding plate 91. when the constraint sliding plate 91 is displaced by the elastic force of the resilient element 92 so as to move the release hole 912 to in a position corresponding to the base hole 902, so that the stud head 22 can sequentially pass through the base hole 902 and the release hole 912 and access into or out of the accommodating space 901 as a in an unlock state. On the other hand, at the time, when the stud head 22 has sequentially passed through the base hole 902 and release hole 912 and enter into the accommodating space 901, the user simply needs to pull down the handheld electronic device 10 so that the mount base 90 will be moved downward simultaneously until the constraint key 909 is embedded into the constraint slot 919, In the meantime, the constraint sliding plate 91 can also be displaced to a position where the engaging groove 913 corresponds to the base hole 902 and the stud pillar 21 is positioned and embedded in the engaging groove 913 in a lock state unable to escape from the engaging groove 913. when the user wants to remove the handheld electronic device 10 from the mount base 90, the user simply needs to press the constraint key 909 to disengage the constraint key 909 from the constraint slot 919, the constraint sliding plate 91 will be automatically turned back to an unlock state by the elastic force applied thereto by the resilient elements 92.

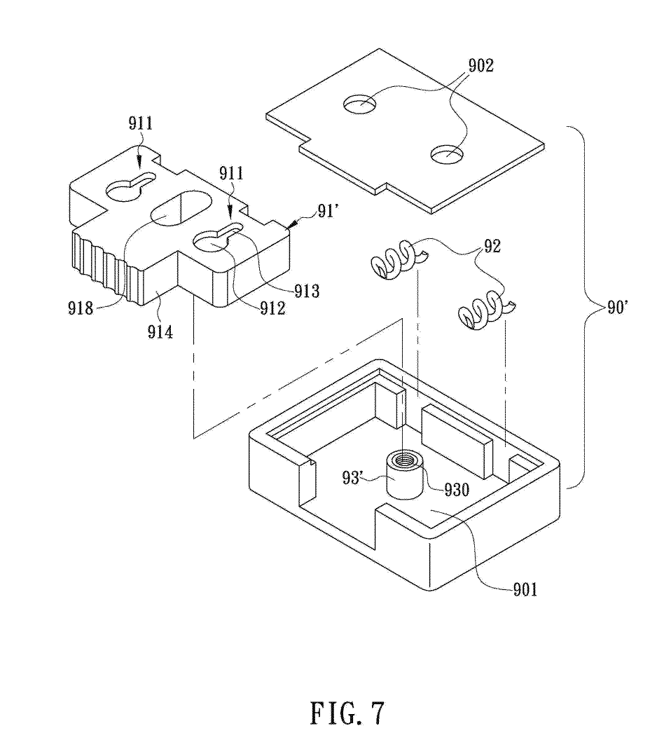

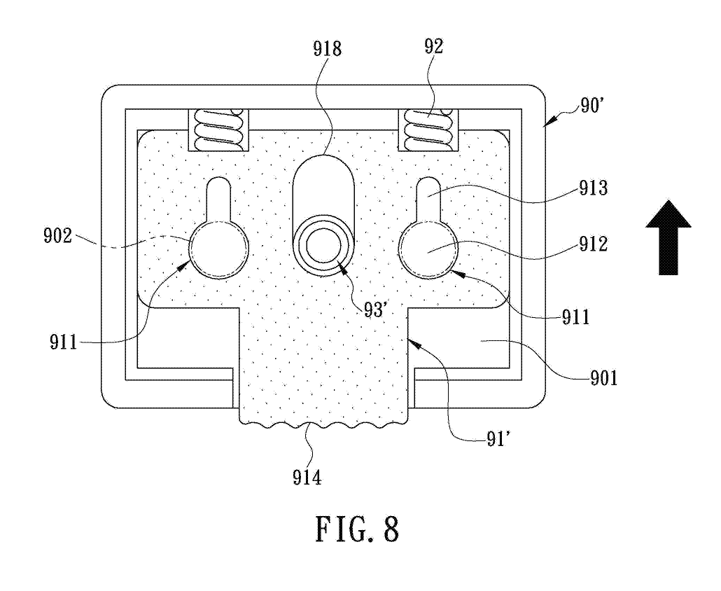

In the second preferred embodiment of the present invention, please again refer to FIGS. 1 and 7, the quick release mount comprises a mount base 90′, a constraint sliding plate 91′, at least an elastic element 92 and an adapter. In subsequent description of the present invention, the bottom of the mount base 90′ is regarded as the front side of the mount base 90 and the upper side of the mount base 90′ is regarded as the rear side of the mount base 90, on behalf of the case for convenience in describing the features of the present invention. The mount base 90′ is provided with an accommodation space 901, and the mount base 902 is provided with two base holes 902 which are spaced apart from each other and in communication with the accommodating space 901, each base hole 902 is larger than the maximum diameter of the stud head 22, and the distance between the base holes 902 is equal to the distance between the stud heads 22 so that the stud head 22 can pass through the base hole 902 and then enter into the accommodating space 901. The constraint sliding plate 91′ is movably mounted in the accommodating space 901, and the constraint sliding plate 91′ is provided with two plate holes 911 each including a release hole 912 and an engaging groove 913 in communication with the release hole 912. The aperture of the release hole 912 is larger than the maximum diameter of the stud head 22, and the groove width of the engaging groove 913 is smaller than the maximum diameter of the stud head 22. A push button 914 is protruded at one end of the constraint sliding plate 91′, and the free end of the push button 914 is exposed outside one end of the mount base 90′. Please refer to FIG. 8. When the push button 914 is pressed by the user, the other end of the constraint sliding plate 91′ can be displaced (in the direction of the arrow) to move the release hole 912 to the position corresponding to the base hole 902 so that the stud head 22 can pass through the base hole 902 and the release hole 912 sequentially, and freely access the accommodating space 901 as in an unlock state.

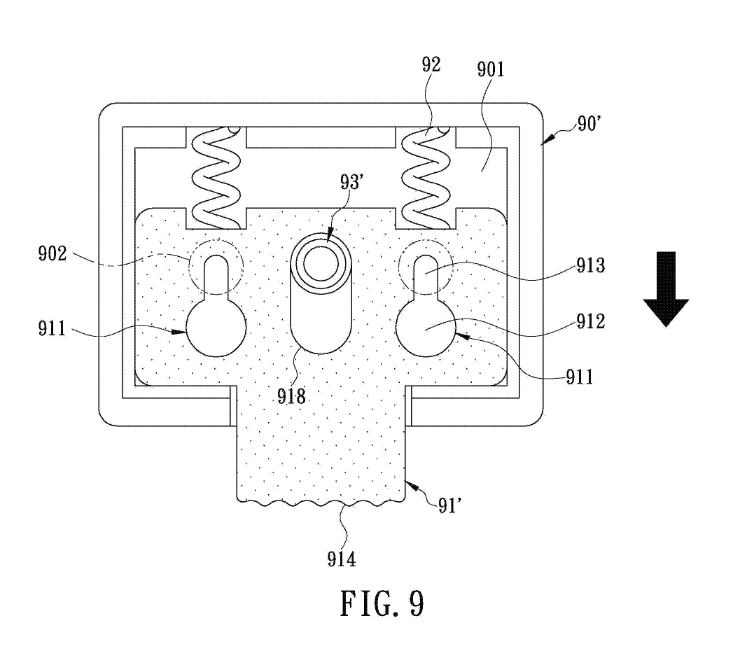

Please again refer to FIGS. 1 and 7. One end of the resilient element 92 is abutted against the inner wall of the mount base 90′ and the other end of the resilient element 92 is abutted against the other end of the constraint sliding plate 91′. Please refer to FIG. 9. The constraint sliding plate 91′ can be displaced (in the direction of the arrow) to a position that the engaging groove 913 corresponds to the base hole 902 due to the resilient force applied thereto by the resilient element 92, thereby enabling the mount base 90′ to be in a lock state while the push button 914 is released, so that the stud pillar 21 can be positioned and embedded in the engaging groove 913 after the stud head 22 sequentially passing through the base hole 902 and the release hole 912 and entering into the accommodating space 901, can not be separated from to become in a lock state. Thus, while the stud pillars 21 of the first and second stud elements 201, 202 protruding on the rear side surface of the handheld electronic device 10 are respectively positioned and embedded in the corresponding engaging grooves 913 of the mount base 90′ in a lock state, the rear side of the handheld electronic device 10 will be securely positioned at the front side of the mount base 90, and completely unable to be moved or rotated.

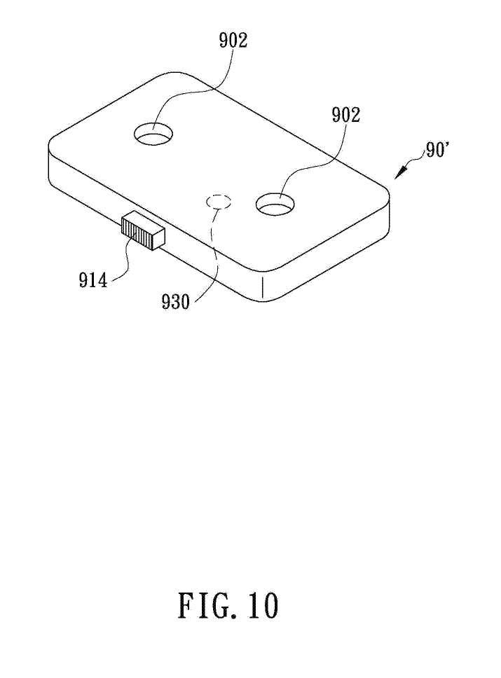

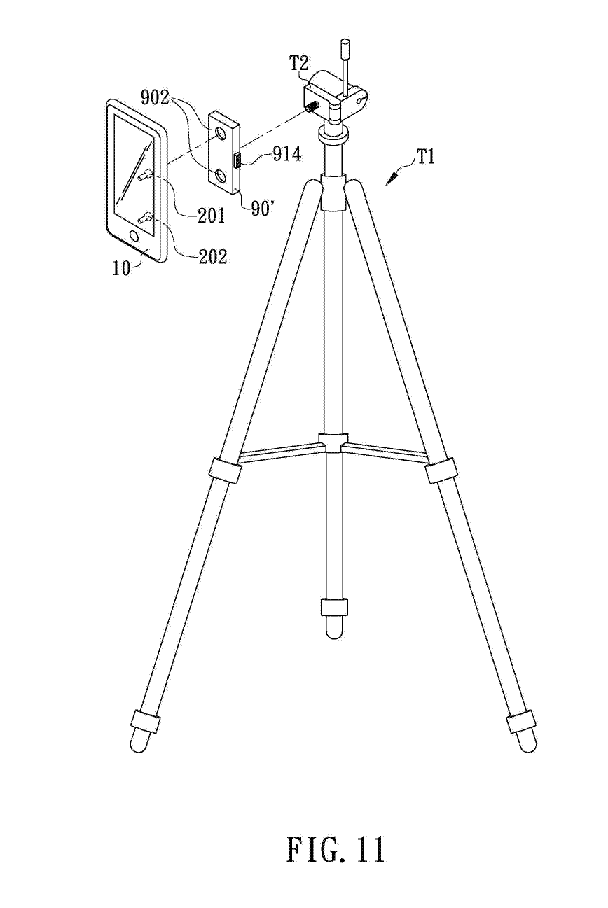

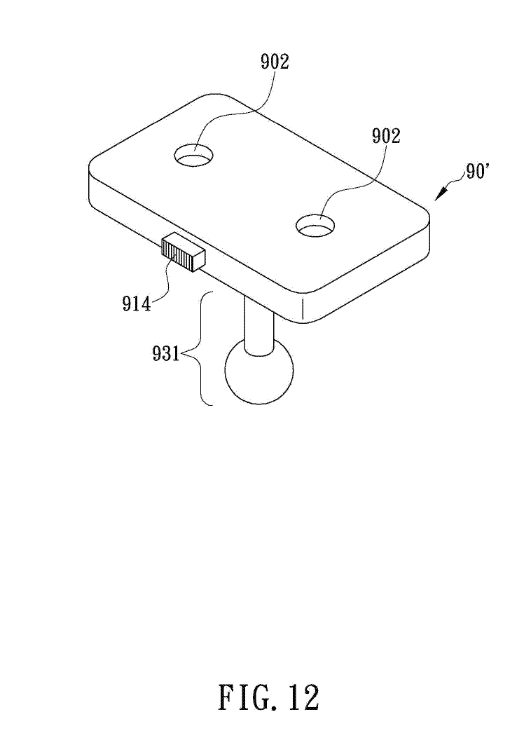

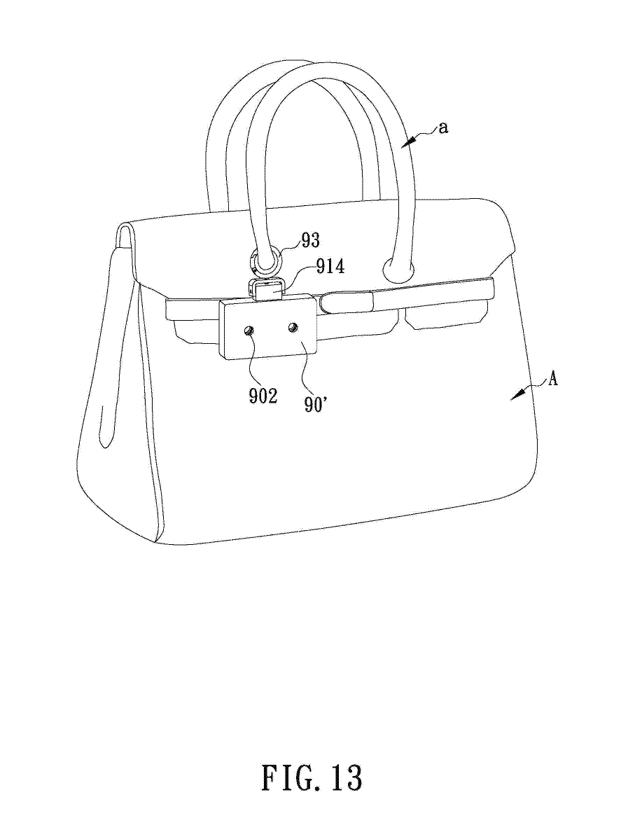

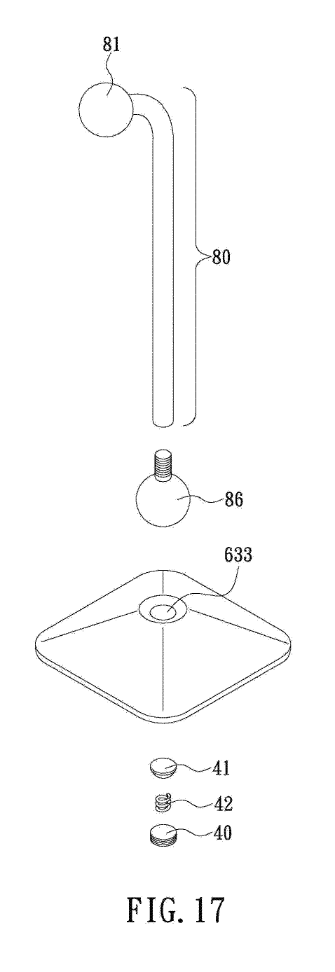

Please again refer to FIGS. 7˜9, in the preferred embodiment of the present invention, another adapter 93′ can be disposed on the rear side of the mount base 90′ (or its edge) for enabling the mount base 90′ ‘to be connected to other objects (e.g., traditional tripods, conventional vehicle brackets, bicycle handles, or locomotive handles . . . ), palm, wrist or arm, wherein the constraint sliding plate 91’ has a chute 918 disposed thereon between the plate holes 911. The adapter 93′ includes an adapting pillar 93′ having one end connected to the base of the mount base 90′ and the other end of the adapting pillar 93′ extends to the chute 918. Please refer to FIGS. 7 and 10. The adapter 93′ further comprises a thread seat 930, wherein The thread seat 930 is installed inside the adapting pillar 93′ and is exposed on the rear side of the mount base 90′. Please refer to FIG. 11. In order to stably connect the handheld electronic device 10 to a conventional tripod T1 or a cradle head T2 so that the user can stably perform lighting, photographing, video recording and the likes through using the handheld electronic device 10. In the other preferred embodiment of the present invention, please referring to FIGS. 7 and 17, the adapter 93′ further includes an adapting rod 931, one end of which is threadedly secured to the thread seat 930, and one of the free ends of the adapting rod 931 is exposed outside the mount base 90′ and can be firmly held by a fixture (Such as one of a variety of spherical fixtures manufactured by an American company namely “RAM MOUNTS”) to facilitate positioning of the handheld electronic device 10 in the front windshield of a vehicle, such as a bicycle, a bicycle, or a bicycle, or a handle of a locomotive or a bicycle, and is capable of stably executing a function such as traffic recording or global positioning (GPS) through the handheld electronic device 10 and reading an instant message received or played by the handheld electronic device 10. However, the adapter of the present invention is not limited to this. In the other embodiment of the present invention, the adapter itself can also be a fixture that allows the user to stably carry out lighting, photographing, video recording or global positioning (GPS) within the operational visual range installed on the handle of the bicycle or locomotive . . . , and other functions. Please refer to FIG. 13. The adapter 93 itself can also be a ring, hanging directly to the portable handbag A, handle a, backpack straps and other objects . . . , etc. Thus, when both hands are doing work and in a state unavailable to hold the handheld electronic device, The handheld electronic device 10 can be securely positioned on an object within the reach of the user's arm and sight, and is easily accessible to a user of the handheld electronic device 10 for viewing or receiving Instant message, or can be removed from the object at any time when needed. The adapter itself can also be a bundle of tight band, the tight band has a flexible or adjustable length of the band body, and the two ends thereof are installed on the mount base 90′ to form a loop together with the mount base 90′ and can be tightened to the user's palm for stabilizing the handheld electronic device 10 when the user manipulates the handheld electronic device 10 in the palm, but not easy to fall from the hands. on the contrary, when the user's both hands are performing other work, and unable to hold the handheld electronic device 10, the tight band can also take advantage of easily and tightly of wearing the handheld electronic device 10 on the user's wrist or arm, so as to ensure that the handheld electronic device 10 is not easy to lose, and can always be located at a position convenient for users to read instant messages on the handheld electronic device 10, or to remove the handheld electronic device 10 from the wrist or arm at any time when needed.

In addition, in order for the handheld electronic device 10 to be quickly and securely positioned on a desk, table, or other object, at a position within a hand reachable and sight visible range of the handheld electronic device 10. In the third preferred embodiment of the present invention, please refer to FIGS. 1, 14, and 15. In addition to the above mentioned mount base 90′, the constraint sliding plate 91′, and the elastic element 92, the quick release mount further includes a support rod 80, a first packing element 70, and a positioning base 60. In subsequent description of the present invention, the left front side of the mount base 90′ is regarded as the front side of the mount base 90′ and the right rear side of the mount base 90′ is regarded as the rear side of the mount base 90′, on behalf of the case for convenience in describing the features of the present invention, wherein the adapting pillar 93′ is protruded on the inner wall of the mount base 90′ and is positioned between the two base holes 903, and the adapting pillar 93′ is provided with a first pivotal slot 931′, the first pivotal slot 931′ is located in the accommodating space 901. The other end of the first pivotal slot 931′ is exposed on the rear side of the mount base 90′, the slot 933′ at the other end of the first pivotal slot 931′ is smaller than the slot hole 932′ at the end of the first pivotal slot 931′. The first pivotal head 81 of the support rod 80 is in sphere shape having a diameter smaller than that of the slot hole 933′ at the other end of the first pivotal slot 931′, but is larger than that of the slot hole 932′ at the end of the first pivotal slot 931′, the diameter of one end of the support rod 80 is smaller than that of the slot hole 933′ at the other end of the first pivotal slot 931′ so that the first pivotal head 81 can be pivoted into the first pivotal slot 931′. The other end of the support rod 80 can be exposed to the rear side of the mount base 90′. The first packing element 70 is mounted in the slot hole 932′ at one end of the first pivotal slot 931′ for urging the free end of the first pivotal head 81 to apply a compression force to the first pivotal head 81 so that when the mount base 90′ is multi-directionally adjusted to any angle relative to the support rod 80, the mount base 90′ can be stably fixed at the angle. The positioning base 60 is connected to the other end of the support rod 80, and the bottom edge of the positioning base 60 can be stably positioned on a desk, a platform, or other objects.

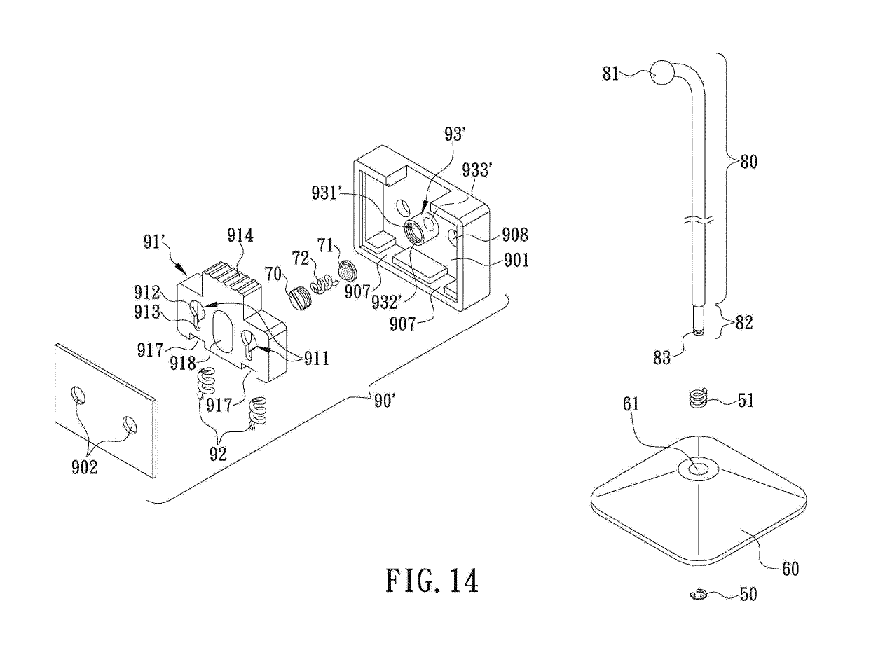

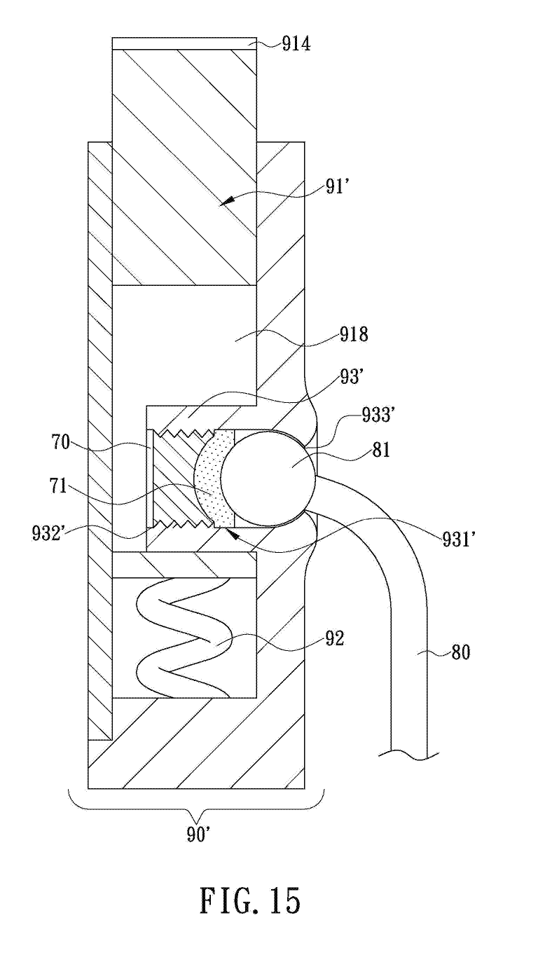

Please again refer to FIGS. 14 and 15. The quick release mount further comprises: a first damping element 71 which is disposed between the first packing element 70 and the first pivotal head e 81 so that the first packing element 70 can apply a large friction force to the first pivotal head 81 through the first damping element 71. The quick release mount further comprises a second elastic element 72, wherein the second elastic element 72 is disposed between the first packing element 70 and the first damping element 71 so that the first packing element 70 can apply a large friction force to the first pivotal head 81 sequentially through the second elastic element 72 And the first damping element 71. In addition, the first packing element 70 can be rotated and screwed into the slot hole 932′ at one end of the first pivotal slot 931′ toward the other end of the first pivotal slot 931′ for adjusting the magnitude of the frictional force exerted on the first pivotal head 81 through the second elastic element 72 And the first damping element 71.

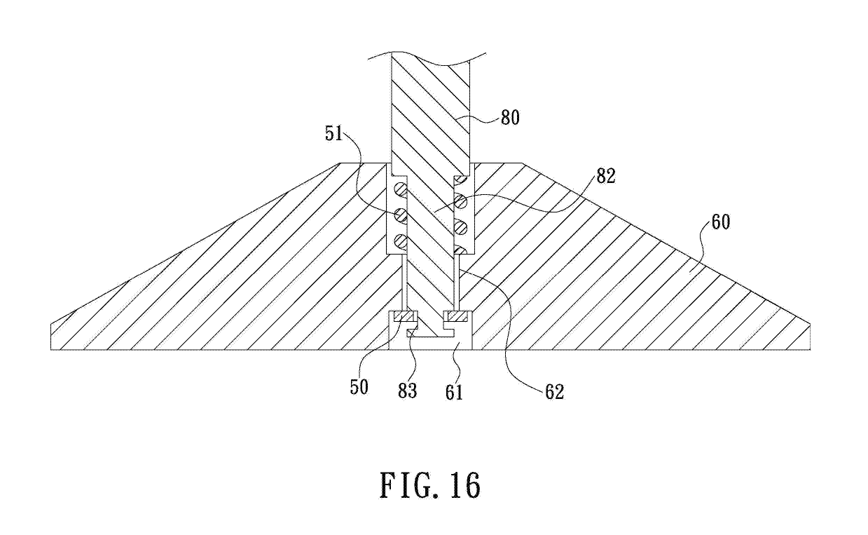

Please again refer to FIG. 14. The other end of the support rod 80 is extended to form an extendable adapting rod 82. The diameter of the extendable adapting rod 82 is less than the diameter of the support adapting rod 80 and an engaging slot 83 is formed on the free end edge of the extendable adapting rod 82. Pleas again refer to FIG. 16. The positioning base 60 has a through hole 61 formed from the top edge to the bottom edge thereof and the through hole 61 is formed with a positioning hole 62. The positioning hole 62 is in communication with the through hole 61 and has a smaller aperture than the through hole 61 so that the other end of the support rod 80 can be inserted into the through hole 61 from the top edge of the positioning base 60 and such that the free end of the extendable adapting rod 82 extends through the positioning hole 62 into a portion of the through hole 61 adjacent to the bottom edge of the positioning base 60 and enables the engaging element 50 to snap into the engaging slot 83. Thus, the other end of the support rod 80 and the engaging element 50 are connected to the top edge of the positioning base 60 and are integrally formed with the diameter of the support rod 80 and the engaging element 50 respectively, so that the support rod 80 can be rotated along the axis of the through hole 61 for adjusting the orientation of support rod 80 with respect to the mount base 90. The extendable adapting rod 82 is capable of being fitted with a third elastic element 51, the third elastic element 51 being abutted against the other end of the support rod 80 and the hole of the positioning hole 62 so that the support rod 80 can be rotated along the axis of the through hole 61 as well as being firmly positioned on the mount base 90, and that the third elastic element 51 may absorbs the impact force while one end of the support rod 80 being collided by external force, and that the support rod 80 is less prone to toppling the mount base 90′.

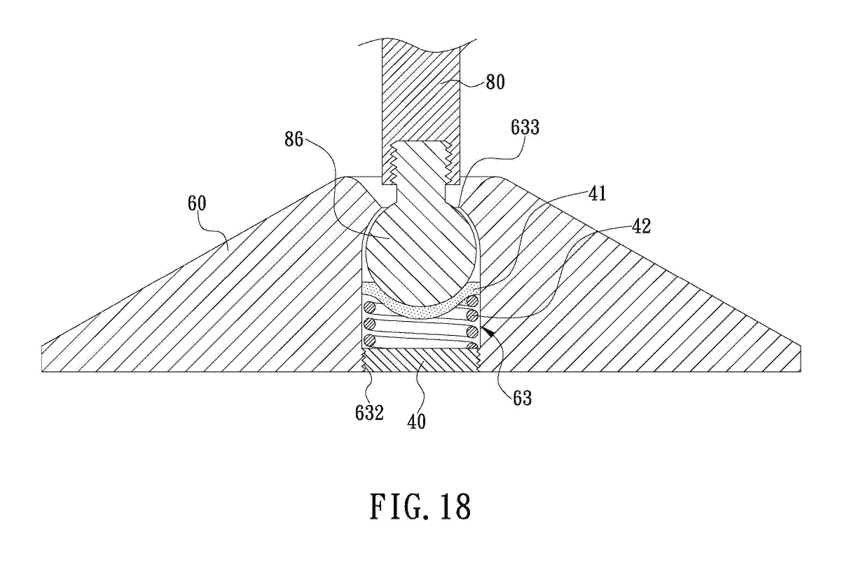

Please again refer to FIGS. 17 and 18. The other end of the support rod 80 is connected with a second pivotal head 86 in a sphere shape, the positioning base 60 has a second pivotal slot 63, wherein one end of the second pivotal slot 63 is exposed at the bottom edge of the positioning base 60 and the other end of the second pivotal slot 63 is exposed at the top edge of the positioning base 60 and has a slot hole 633 smaller than the slot hole 632 at the end of the second pivotal slot 63 And the diameter of the other end of the support rod 80 is smaller than that of the second pivotal slot 63 and the slot hole 633 at the other end thereof so that the second pivotal head 86 can be pivoted into the second pivotal slot 63. Please again refer to FIGS. 17 and 18. the quick release mount further comprises a second packing element 40, installed inside the slot hole 632 at one end of the second pivotal slot 63 for allowing the support rod 80 to be exposed at the top edge of the positioning base 60; the packing element 40 can be rotated inside the slot hole 632 at one end of the second pivotal slot 6 for applying a compression and friction force to the free end of the second pivotal head 86. Thus, while the support rod 80 is multi-directionally adjusted to any angles with respect to the positioning base 60, the support rod 80 can be stably fixed on any angle.

Please again refer to FIGS. 17 and 18. The quick release mount also includes a second damping element 41, which is located between the second packing element 40 and the second pivotal head 86 so that the second packing member 40 can exerts a relatively large friction force against the second pivotal head 86 through the second damping element 41. The quick release mount includes a fourth elastic element 42. The fourth release element 42 is disposed between the second packing element 40 and the second damping element 41 so that the second packing element 40 can exert a compulsive frictional force against the second pivotal head 86 sequentially through the fourth elastic element 42 and the second damping element 41 Besides, since the second packing element 40 can be screwed into the slot hole 632 at one end of the second pivotal slot 63 and is capable of being rotated towards the other end of the second pivotal slot 63, so that the amount of the force applied to the second pivotal head 86 can easily be adjusted through the second packing element 40. In order to increase the pivotal friction of, the support rod 80 so as to ensure the support rod 80 can be rotated as well as being more securely positioned outside the positioning base 60 even when one end of the support rod 80 or the positioning base 60 is collided by other object, due to the fourth elastic element 42 is able to effectively absorb the collision force, and never let the collision force affect the stability of the support rod 80 and the positioning base 90′.

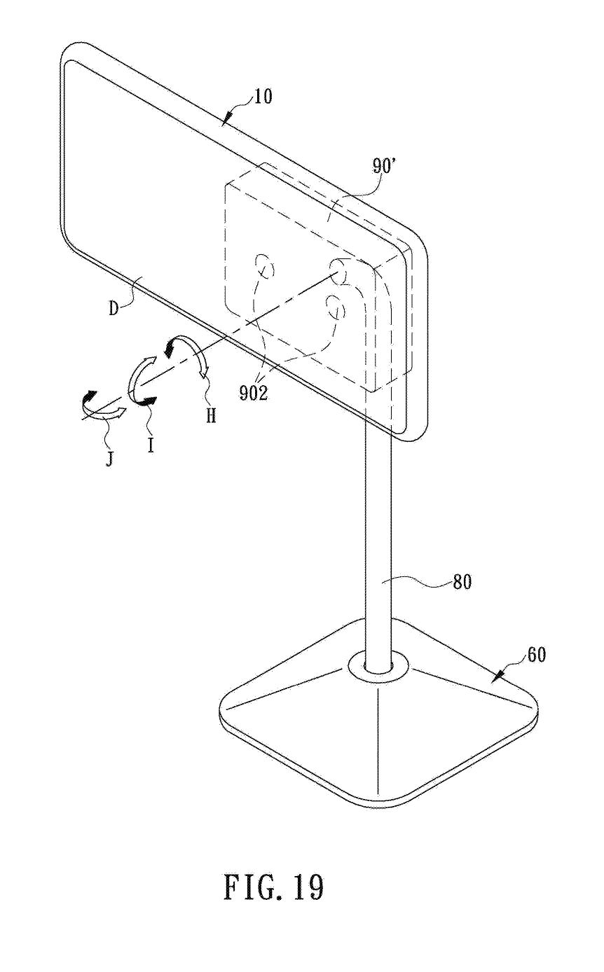

Thus, while using the quick release mount, please refer to FIGS. 1 and 19, the user may first put the button edge of the positioning base 60 on a desk, a table or other objects. When both hands are doing work and in a state unavailable to hold the handheld electronic device 10 or the user doesn't use the handheld electronic device 10, the user only need to insert the first stud element 201 and the second stud element 202 protruding on the rear side of the handheld electronic device 10 into the base hole 902 on the front side of the mount base 90′ so that the handheld electronic device 10 can be in a lock state on the mount base 90′ unable to escape from the mount base 90′, and is then located within a hand reachable and sight visible range, not only making the handheld electronic device 10 not easy to be lost, but also making the handheld electronic device 10 available for being adjusted according to user's demand, such as rotating the handheld electronic device 10 (in the direction of the arrow H), adjusting the orientation (horizontally or vertically) or height (upright (upright)) of the handheld electronic device 10, adjusting the view direction of the user (or the view direction of the arrow I or J) with respect to the handheld electronic device or adjusting the pitch, left or right tilt angles of the handheld electronic device 10, and available for taking the handheld electronic device 10 out from the mount base 90′at any time when needed. In addition, when the user is at home, place of work, public places (such as: restaurants, stores, playgrounds or libraries . . . ) to deal with things, or is doing traffic or travelling recording by using video camera of the handheld electronic device 10, the user only need to put the edge of the mount base 90′ and the handheld electronic device 10 on the desktop, table, rack or other appropriate location, no need to remove the handheld electronic device 10 from the mount base 90′. The user can still review the instant massage on display screen of the handheld electronic device 10 or perform relative function provided by the handheld electronic device 10 (such as, light, camera, photograph, video recording, or GPS (Global Positioning) . . . , etc. In addition, since the handheld electronic device 10 is positioned to the mount base 90′, the user is able to multi-directionally adjust the display screen D of the orientation, angle, and height of the handheld electronic device 10 with respect to the mount base 90′, so that the handheld electronic device 10 can be easily manipulated by the user for stably performing the foregoing functions of the handheld electronic device 10.

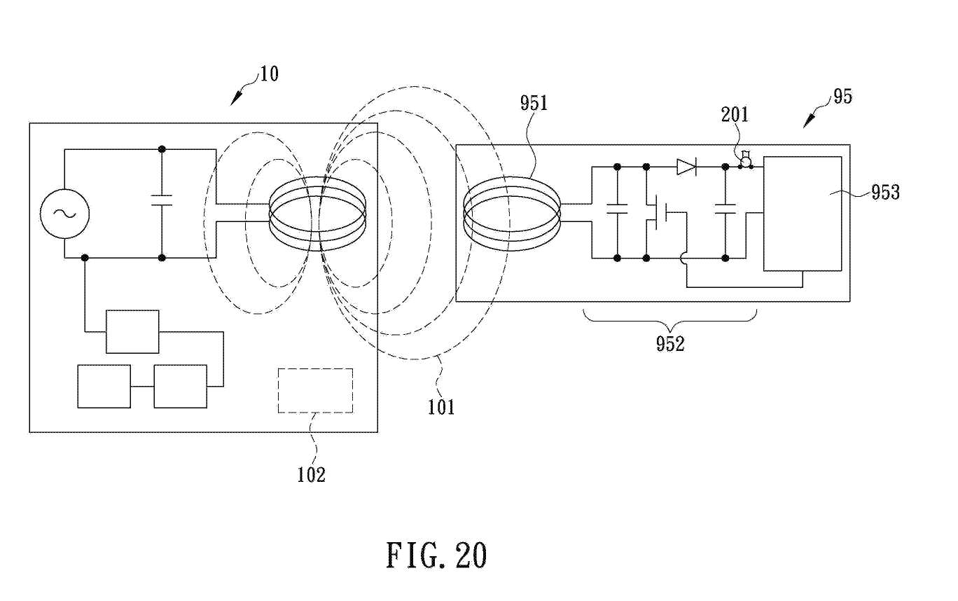

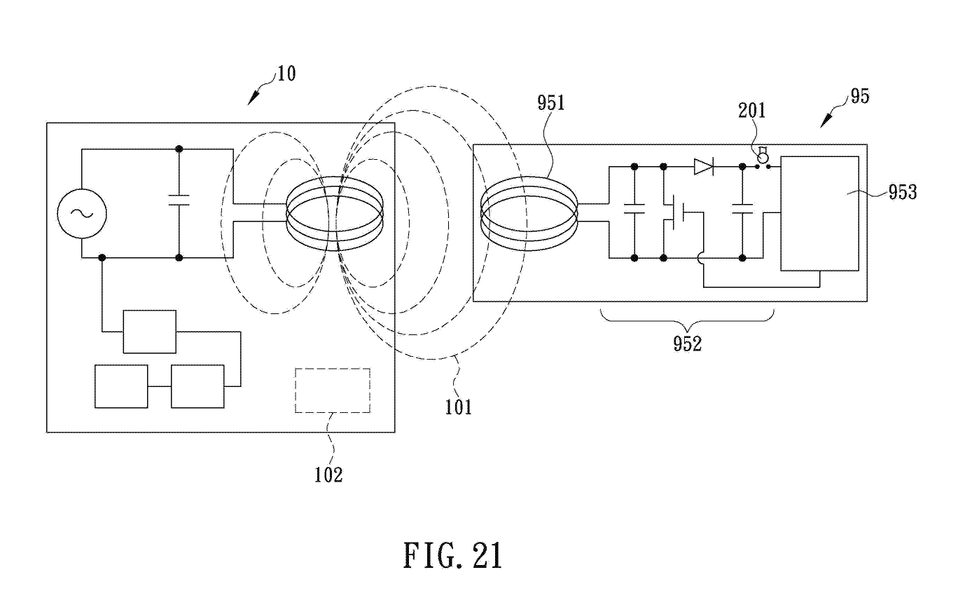

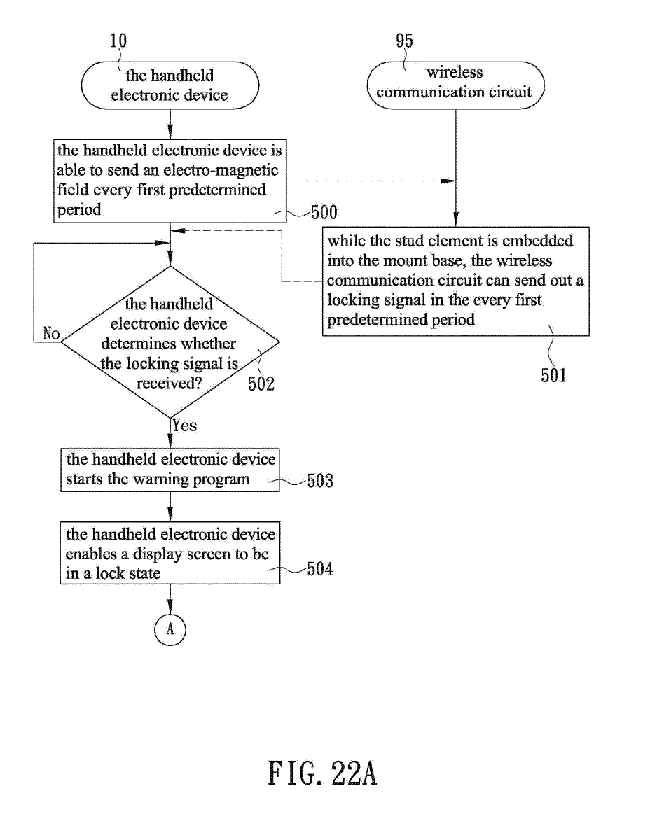

In the fourth preferred embodiment of the present invention, please refer to FIGS. 20 and 21, further comprising a wireless communication circuit 95 which is installed inside the mount base 90′ (or 90), on the condition that the first stud element 201 (and/or) the second stud element 202 is positioned to the mount base 90′, the wireless communication circuit 95 can be driven to send out a locking signal every the first predetermined period. While the handheld electronic device 10 didn't receive the locking signal within a second predetermined period, the handheld electronic device 10 will generate and send out an alert signal, wherein the second predetermined period is longer than the first predetermined period.

In the above preferred embodiment of the present invention, please refer to FIG. 20, the wireless communication circuit 95 comprise: a communication antenna 951, an activating circuit 952, and a passive wireless communication chip 953, wherein the communication antenna 951 is connected with the wireless communication chip 953 through the activating circuit 952, the communication antenna 951 can receive a electro-magnetic field 101 (electro-magnetic field) garnered by the handheld electronic device 10 and generates an induced current through the activating circuit 952 to drive the wireless communication chip 953 to send the locking signal out through the communication antenna 951. Thus, the wireless communication circuit 95 can be completely without needing additional power supply (such as the installation of batteries), while the handheld electronic device 10 is put near within a predetermined rang with the wireless communication circuit 95, and the generated electro-magnetic field 101 is sufficient to sequentially propagate the communication antenna 951 and the activating circuit 952 to produce the induced current. After the passive wireless communication chip 953 receive the induced current, the wireless communication chip 953 will send out the locking signal; on the contrary, while the handheld electronic device 10 is not in the predetermined rang, passive wireless communication chip 953 will not send out the locking signal due to not receiving the induced current. Accordingly, the wireless communication chip 953 can be a passive Near Field Communication chip (hereinafter referred to as a passive NFC chip) or a passive Radio Frequency Identification chip (hereinafter referred to as a passive RFID chip).

In addition, in order to prevent the wireless communication chip 953 from too close to the handheld electronic device 10 to be driven and generating the locking signal leading the handheld electronic device 10 to misjudge and occurs an error alert signal to be sent out. Please refer to FIG. 20. The wireless communication circuit 95 can only be turned on in a short circuit status, by the first stud element 201 while the first stud element 201 (and/or second stud element 202) is inserted into the mount base 90′ and the wireless communication chip 953 can only be driven while receiving the induced current and then send out the locking signal; on the contrary. Please refer to FIG. 21. If the first stud element 201 (and/or the second stud element 202) is not inserted into the mount base 90′ and the wireless communication circuit 95 is in a broken circuit status. The wireless communication chip 953 is unable to be driven to send out the locking signal due to not receiving the induced current.

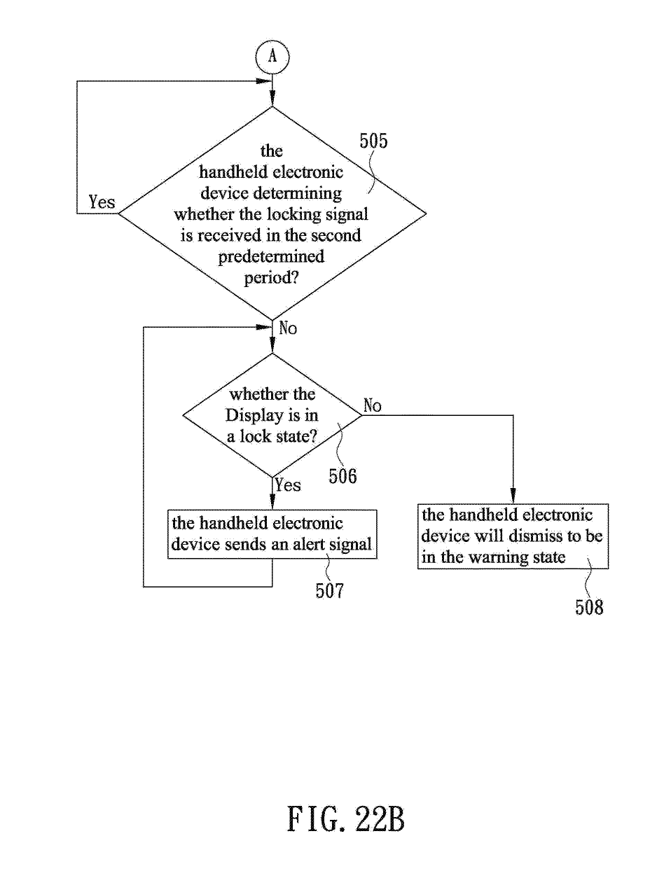

Please again refer to FIG. 1. The handheld electronic device 10 is installed a warning program 102 inside. The stud element 201 (and/or 202) protruding on the rear side of the handheld electronic device 10 can be inserted into the mount base 90′. Please refer to FIGS. 22A and 22B. The handheld electronic device 10 and the wireless communication circuit 95 will perform the following steps:

(500) please again refer to FIG. 20. The handheld electronic device 10 is able to send an electro-magnetic field 101 every first predetermined period;

(501) while the stud element 201 (and/or 202) is embedded into the mount base 90′, the wireless communication circuit 95 can be activated by the stud element 201 (and/or 202) and receive the electro-magnetic field 101 for generating a induced current and then sending out a locking signal in the every first predetermined period;

(502) the handheld electronic device 10 determines whether the locking signal is received? If yes, go on step (503). If no, repeat step (502);

(503) the handheld electronic device 10 starts the warning program 102 to command the handheld electronic device 10 to be in a warning state;

(504) the handheld electronic device 10, according to the warning program 102, enables a display screen D of the handheld electronic device 10 to be in a lock state, such as: turning the display screen D of the handheld electronic device 10 to be a regular dark screen except when the user inputs a secret code to the handheld electronic device 10 so that the display screen D can then be turned back to be in a in an unlock and normal use state;

(505) the handheld electronic device 10, according to the warning program 102, determining whether the locking signal is received in the second predetermined period? wherein the second predetermined period is longer than the first predetermined period. If yes, repeat step (505). If no, go on step (506);

(506) the handheld electronic device 10, according to the warning program 102, determining whether the Display is in a lock state? If yes, go on step (507). If no, go on step (508);

(507) the handheld electronic device 10 sends an alert signal (such as: warning light and/or warning sound) to give a warning, and repeat step (506); and

(508) the handheld electronic device 10 will dismiss to be in the warning state and stop sending the alert signal.

Thus, in case both hands of the user are doing work and unavailable to hold the handheld electronic device 10 or the user doesn't use the handheld electronic device 10, and the handheld electronic device 10 can be fixed on the quick release mount, and can be in a lock state unable to escape from the quick release mount. If the malicious others without the permission to take away the handheld electronic device 10 from the quick release mount, the handheld electronic device 10 is unable to receive the locking signal within the second predetermined period, then the handheld electronic device 10 will send out the alert signal (such as, a warning light and/or a warning sound) to warn the user that the handheld electronic device 10 has been took away by others in a bad intention in sequence for the user to get the handheld electronic device 10 back in time and effectively refrain the handheld electronic device 10 from being took away by others in a bad intention; on the contrary, while the user took away the handheld electronic device 10 from the quick release mount himself, the user only needs to unlock the display screen D of the handheld electronic device 10 within the second predetermined period to dismiss the handheld electronic device 10 from the warning state and the display screen D of the handheld electronic device 10 will thus be immediately turned back to an unlock and normal uses state.

While the invention herein disclosed has been described by means of specific embodiments, numerous modifications and variations could be made thereto by those skilled in the art without departing from the scope of the invention set forth in the claims.

What is claimed is:

1. A quick release mount for holding handheld electronic device, wherein the handheld electronic device comprises: at least a stud element, the stud element including a stud pillar and a stud head, one end of the stud pillar is protruding on the rear side of the handheld electronic device, one end of the stud head is connected with another end of the stud pillar, the largest cross-section of the stud head is greater than that of the stud pillar, the quick release mount comprises:
a mount base providing a accommodating space therein with at least a base hole at the front side thereof, wherein diameter of the base hole is greater than the stud head for enabling the stud head to pass through the base hole and then to be accommodated in the accommodating space;
a constraint sliding plate being movably installed inside the accommodating space, the constraint sliding plate is provided with at least a plate hole, The constraint sliding plate has a push button disposed at one end thereof and a free end of the push button is exposed outside one end of the mount base, the constraint sliding plate can be shifted for enabling the stud head to pass through the base hole and the plate hole sequentially, and to be in an unlock state capable of freely accessing the accommodating space, or for enabling the stud pillar to be embedded in the plate hole and in a lock state unable to escape from the plate hole; and
at least an elastic element leaning against and between the mount base and the constraint sliding plate.

2. The quick release mount according to claim 1, wherein the diameter of the base hole is greater than the maximum diameter of the stud head so that the stud head can pass through the base hole and access to the accommodating space, the plate hole includes a release hole and an engaging groove in communication with the release hole, the aperture of the release hole is larger than the maximum diameter of the stud head, the groove width of the engaging groove is smaller than the maximum diameter of the stud head, but greater than the diameter of the stud pillar, the constraint sliding plate can be displaced for enabling the release hole to correspond to the position of the base hole so that the stud head can pass through the base hole and release hole sequentially and freely enter and leave the accommodating space as in the unlock state, or for enabling the engaging groove to correspond to the position of the base hole, so that the stud head can pass through the base hole and release hole sequentially, and be accommodated in the accommodating space, so that the stud pillar is embedded in the engaging groove and in the lock state unable to escape from the plate hole.

3. The quick release mount according to claim 2, wherein the rear side of the constraint sliding plate corresponding to the position of the engaging groove is provided with an abutting portion on both sides of the engaging groove, the thickness of the abutment portions is larger than the thickness of the constraint sliding plate corresponding thereto and is increased gradually in the direction away from the release hole so that when the stud head sequentially passing through the base hole and the release hole and being accommodated into the accommodating space, and when the stud pillar being embedded into for enabling the rear side of the handheld electronic device to be in contact against the front side of the mount base.

4. The quick release mount according to claim 3, wherein the rear side of the mount base corresponds to the position of the base hole has a penetrating hole disposed thereon, the penetrating hole is in communication with the accommodating space and diameter of the penetrating hole is greater than the maximum diameter of the stud head.

5. The quick release mount according to claim 4, comprising a adapter which is located at the free end of the button or the periphery of the mount base for enabling the quick release mount to be mounted to other objects.

6. The quick release mount according to claim 4, wherein number of the stud element, the base hole and the plate hole are two, respectively, and the stud elements, the base holes and the plate holes are separated from each other.

7. The quick release mount according to claim 6, wherein the constraint sliding plate further includes a chute disposed between the plate holes, the quick release mount further includes an adapter, wherein the adapter comprising an adapting pillar, one end of the adapting pillar is integrally connected to the bottom of the mount base, and the other end of the adapting pillar is extending to the chute.

8. The quick release mount according to claim 7, wherein the adapter further comprises a thread seat mounted in the adapting pillar and exposed on the rear side of the mount base

9. The quick release mount according to claim 8, wherein the adapter further comprises an adapting rod, one end of the adapting rod is threadedly secured within the thread seat, the free end of the adapting rod is formed with a spherical head exposed outside the rear side of the mount base for being firmly held by a clamp.

10. The quick release mount according to claim 7, wherein the adapting pillar is provided with a first pivotal slot in which one end of the first pivotal slot is located in the accommodating space and the other end of the first pivotal slot is exposed on the rear side of the mount base, the slot hole at the other end of the first pivotal slot is smaller than the slot hole at the end of the first pivotal slot, wherein the quick release mount further comprises:
a support rod having a first pivotal head in sphere shape disposed at one end thereof and maximum diameter of the first pivotal head is smaller than the slot hole at one end of the first pivotal slot but larger than the slot hole at the other end of the first pivotal slot, diameter of the support rod is smaller than the slot hole of the first pivotal slot so that the first pivotal head can be pivoted to the first pivotal slot and the other end of the support rod can be exposed on the rear side of the mount base;
a first packing element mounted in the slot hole at one end of the first pivotal slot for urging the free end of the first pivotal head to apply a pressing friction force to the first pivotal head; and
a positioning base whose top edge is connected to the other end of the support rod and whose bottom edge can be firmly positioned onto the other object.

11. The quick release mount according to claim 10, including a first damping element, wherein the first damping element is installed between the first packing element and the first pivotal head, such that the first packing element can apply the pressing friction force to the first pivotal head through the first damping element.

12. The quick release mount according to claim 11, further comprising a second elastic element, wherein the second elastic element is located between the first packing element and the first damping element so that the first packing element can, apply the pressing friction force to the first pivotal head through the second elastic element and the first damping element sequentially.

13. The quick release mount according to claim 12, wherein the first packing element is screwed into the slot hole at one end of the first pivotal slot and is capable of being rotated towards the other end of the first pivotal slot for adjusting the pressing friction force applied to the first pivotal head.

14. The quick release mount according to claim 1, further comprising a wireless communication circuit installed in the mount base, when the stud element is protruding in the plate hole and embedded into the plate hole, the wireless communication circuit can be driven by the stud element to generate and sent out a locking signal every predetermined time period, until the stud elements are no more embedded into the plate hole.

15. The quick release mount according to claim 2, further comprising a wireless communication circuit installed in the mount base, when the stud element is protruding in the plate hole and embedded into the plate hole, the wireless communication circuit can be driven by the stud element to generate and sent out a locking signal every predetermined time period, until the stud elements are no more embedded into the plate hole.

16. The quick release mount according to claim 3, further comprising a wireless communication circuit installed in the mount base, when the stud element is protruding in the plate hole and embedded into the plate hole, the wireless communication circuit can be driven by the stud element to generate and sent out a locking signal every predetermined time period, until the stud elements are no more embedded into the plate hole.

17. The quick release mount according to claim 4, further comprising a wireless communication circuit installed in the mount base, when the stud element is protruding in the plate hole and embedded into the plate hole, the wireless communication circuit can be driven by the stud element to generate and sent out a locking signal every predetermined time period, until the stud elements are no more embedded into the plate hole.

18. The quick release mount according to claim 5, further comprising a wireless communication circuit installed in the mount base, when the stud element is protruding in the plate hole and embedded into the plate hole, the wireless communication circuit can be driven by the stud element to generate and sent out a locking signal every predetermined time period, until the stud elements are no more embedded into the plate hole.

19. The quick release mount according to claim 6, further comprising a wireless communication circuit installed in the mount base, when the stud element is protruding in the plate hole and embedded into the plate hole, the wireless communication circuit can be driven by the stud element to generate and sent out a locking signal every predetermined time period, until the stud elements are no more embedded into the plate hole.

20. The quick release mount according to claim 7, further comprising a wireless communication circuit installed in the mount base, when the stud element is protruding in the plate hole and embedded into the plate hole, the wireless communication circuit can be driven by the stud element to generate and sent out a locking signal every predetermined time period, until the stud elements are no more embedded into the plate hole.

21. The quick release mount according to claim 8, further comprising a wireless communication circuit installed in the mount base, when the stud element is protruding in the plate hole and embedded into the plate hole, the wireless communication circuit can be driven by the stud element to generate and sent out a locking signal every predetermined time period, until the stud elements are no more embedded into the plate hole.

22. The quick release mount according to claim 9, further comprising a wireless communication circuit installed in the mount base, when the stud element is protruding in the plate hole and embedded into the plate hole, the wireless communication circuit can be driven by the stud element to generate and sent out a locking signal every predetermined time period, until the stud elements are no more embedded into the plate hole.

23. The quick release mount according to claim 10, further comprising a wireless communication circuit installed in the mount base, when the stud element is protruding in the plate hole and embedded into the plate hole, the wireless communication circuit can be driven by the stud element to generate and sent out a locking signal every predetermined time period, until the stud elements are no more embedded into the plate hole.

24. The quick release mount according to claim 11, further comprising a wireless communication circuit installed in the mount base, when the stud element is protruding in the plate hole and embedded into the plate hole, the wireless communication circuit can be driven by the stud element to generate and sent out a locking signal every predetermined time period, until the stud elements are no more embedded into the plate hole.

25. The quick release mount according to claim 12, further comprising a wireless communication circuit installed in the mount base, when the stud element is protruding in the plate hole and embedded into the plate hole, the wireless communication circuit can be driven by the stud element to generate and sent out a locking signal every predetermined time period, until the stud elements are no more embedded into the plate hole.

26. The quick release mount according to claim 13, further comprising a wireless communication circuit installed in the mount base, when the stud element is protruding in the plate hole and embedded into the plate hole, the wireless communication circuit can be driven by the stud element to generate and sent out a locking signal every predetermined time period, until the stud elements are no more embedded into the plate hole.

27. The quick release mount according to claim 14, wherein the wireless communication circuit comprises a communication antenna, an activating circuit, and a passive wireless communication chip; wherein the communication antenna is electrically connected with the passive wireless communication chip through the activating circuit, the communication antenna receives an electromagnetic field generated by the handheld electronic device and generates an induced current through the activating circuit to drive the passive wireless communication chip to generate and transmit the locking signal through the communication antenna.

28. The quick release mount according to claim 15, wherein the wireless communication circuit comprises a communication antenna, an activating circuit, and a passive wireless communication chip; wherein the communication antenna is electrically connected with the passive wireless communication chip through the activating circuit, the communication antenna receives an electromagnetic field generated by the handheld electronic device and generates an induced current through the activating circuit to drive the passive wireless communication chip to generate and transmit the locking signal through the communication antenna.

29. The quick release mount according to claim 16, wherein the wireless communication circuit comprises a communication antenna, an activating circuit, and a passive wireless communication chip; wherein the communication antenna is electrically connected with the passive wireless communication chip through the activating circuit, the communication antenna receives an electromagnetic field generated by the handheld electronic device and generates an induced current through the activating circuit to drive the passive wireless communication chip to generate and transmit the locking signal through the communication antenna.

30. The quick release mount according to claim 17, wherein the wireless communication circuit comprises a communication antenna, an activating circuit, and a passive wireless communication chip; wherein the communication antenna is electrically connected with the passive wireless communication chip through the activating circuit, the communication antenna receives an electromagnetic field generated by the handheld electronic device and generates an induced current through the activating circuit to drive the passive wireless communication chip to generate and transmit the locking signal through the communication antenna.

31. The quick release mount according to claim 18, wherein the wireless communication circuit comprises a communication antenna, an activating circuit, and a passive wireless communication chip; wherein the communication antenna is electrically connected with the passive wireless communication chip through the activating circuit, the communication antenna receives an electromagnetic field generated by the handheld electronic device and generates an induced current through the activating circuit to drive the passive wireless communication chip to generate and transmit the locking signal through the communication antenna.

32. The quick release mount according to claim 19, wherein the wireless communication circuit comprises a communication antenna, an activating circuit, and a passive wireless communication chip; wherein the communication antenna is electrically connected with the passive wireless communication chip through the activating circuit, the communication antenna receives an electromagnetic field generated by the handheld electronic device and generates an induced current through the activating circuit to drive the passive wireless communication chip to generate and transmit the locking signal through the communication antenna.

33. The quick release mount according to claim 20, wherein the wireless communication circuit comprises a communication antenna, an activating circuit, and a passive wireless communication chip; wherein the communication antenna is electrically connected with the passive wireless communication chip through the activating circuit, the communication antenna receives an electromagnetic field generated by the handheld electronic device and generates an induced current through the activating circuit to drive the passive wireless communication chip to generate and transmit the locking signal through the communication antenna.

34. The quick release mount according to claim 21, wherein the wireless communication circuit comprises a communication antenna, an activating circuit, and a passive wireless communication chip; wherein the communication antenna is electrically connected with the passive wireless communication chip through the activating circuit, the communication antenna receives an electromagnetic field generated by the handheld electronic device and generates an induced current through the activating circuit to drive the passive wireless communication chip to generate and transmit the locking signal through the communication antenna.

35. The quick release mount according to claim 22, wherein the wireless communication circuit comprises a communication antenna, an activating circuit, and a passive wireless communication chip; wherein the communication antenna is electrically connected with the passive wireless communication chip through the activating circuit, the communication antenna receives an electromagnetic field generated by the handheld electronic device and generates an induced current through the activating circuit to drive the passive wireless communication chip to generate and transmit the locking signal through the communication antenna.

36. The quick release mount according to claim 23, wherein the wireless communication circuit comprises a communication antenna, an activating circuit, and a passive wireless communication chip; wherein the communication antenna is electrically connected with the passive wireless communication chip through the activating circuit, the communication antenna receives an electromagnetic field generated by the handheld electronic device and generates an induced current through the activating circuit to drive the passive wireless communication chip to generate and transmit the locking signal through the communication antenna.

37. The quick release mount according to claim 24, wherein the wireless communication circuit comprises a communication antenna, an activating circuit, and a passive wireless communication chip; wherein the communication antenna is electrically connected with the passive wireless communication chip through the activating circuit, the communication antenna receives an electromagnetic field generated by the handheld electronic device and generates an induced current through the activating circuit to drive the passive wireless communication chip to generate and transmit the locking signal through the communication antenna.

38. The quick release mount according to claim 25, wherein the wireless communication circuit comprises a communication antenna, an activating circuit, and a passive wireless communication chip; wherein the communication antenna is electrically connected with the passive wireless communication chip through the activating circuit, the communication antenna receives an electromagnetic field generated by the handheld electronic device and generates an induced current through the activating circuit to drive the passive wireless communication chip to generate and transmit the locking signal through the communication antenna.

39. The quick release mount according to claim 26, wherein the wireless communication circuit comprises a communication antenna, an activating circuit, and a passive wireless communication chip; wherein the communication antenna is electrically connected with the passive wireless communication chip through the activating circuit, the communication antenna receives an electromagnetic field generated by the handheld electronic device and generates an induced current through the activating circuit to drive the passive wireless communication chip to generate and transmit the locking signal through the communication antenna.

40. The quick release mount according to claim 27, the passive wireless communication chip is a passive Near Field Communication chip or a passive Radio Frequency Identification chip.

41. The quick release mount according to claim 28, the passive wireless communication chip is a passive Near Field Communication chip or a passive Radio Frequency Identification chip.

42. The quick release mount according to claim 29, the passive wireless communication chip is a passive Near Field Communication chip or a passive Radio Frequency Identification chip.

43. The quick release mount according to claim 30, the passive wireless communication chip is a passive Near Field Communication chip or a passive Radio Frequency Identification chip.

44. The quick release mount according to claim 31, the passive wireless communication chip is a passive Near Field Communication chip or a passive Radio Frequency Identification chip.

45. The quick release mount according to claim 32, the passive wireless communication chip is a passive Near Field Communication chip or a passive Radio Frequency Identification chip.

46. The quick release mount according to claim 33, the passive wireless communication chip is a passive Near Field Communication chip or a passive Radio Frequency Identification chip.

47. The quick release mount according to claim 34, the passive wireless communication chip is a passive Near Field Communication chip or a passive Radio Frequency Identification chip.

48. The quick release mount according to claim 35, the passive wireless communication chip is a passive Near Field Communication chip or a passive Radio Frequency Identification chip.

49. The quick release mount according to claim 36, the passive wireless communication chip is a passive Near Field Communication chip or a passive Radio Frequency Identification chip.

50. The quick release mount according to claim 37, the passive wireless communication chip is a passive Near Field Communication chip or a passive Radio Frequency Identification chip.

51. The quick release mount according to claim 38, the passive wireless communication chip is a passive Near Field Communication chip or a passive Radio Frequency Identification chip.

52. The quick release mount according to claim 39, the passive wireless communication chip is a passive Near Field Communication chip or a passive Radio Frequency Identification chip.

53. The quick release mount according to claim 40, wherein, when the stud element is not embedded in the plate hole, the communication circuit is in a broken circuit status and is unable to be driven to generate and send out the locking signal; on the contrary, when the stud element is embedded in the plate hole, the wireless communication circuit can be activated by the stud element and be in an unlock state and be driven to generate and send out the locking signal.

54. The quick release mount according to claim 41, wherein, when the stud element is not embedded in the plate hole, the communication circuit is in a broken circuit status and is unable to be driven to generate and send out the locking signal; on the contrary, when the stud element is embedded in the plate hole, the wireless communication circuit can be activated by the stud element and be in an unlock state and be driven to generate and send out the locking signal.

55. The quick release mount according to claim 42, wherein, when the stud element is not embedded in the plate hole, the communication circuit is in a broken circuit status and is unable to be driven to generate and send out the locking signal; on the contrary, when the stud element is embedded in the plate hole, the wireless communication circuit can be activated by the stud element and be in an unlock state and be driven to generate and send out the locking signal.

56. The quick release mount according to claim 43, wherein, when the stud element is not embedded in the plate hole, the communication circuit is in a broken circuit status and is unable to be driven to generate and send out the locking signal; on the contrary, when the stud element is embedded in the plate hole, the wireless communication circuit can be activated by the stud element and be in an unlock state and be driven to generate and send out the locking signal.

57. The quick release mount according to claim 44, wherein, when the stud element is not embedded in the plate hole, the communication circuit is in a broken circuit status and is unable to be driven to generate and send out the locking signal; on the contrary, when the stud element is embedded in the plate hole, the wireless communication circuit can be activated by the stud element and be in an unlock state and be driven to generate and send out the locking signal.

58. The quick release mount according to claim 45, wherein, when the stud element is not embedded in the plate hole, the communication circuit is in a broken circuit status and is unable to be driven to generate and send out the locking signal; on the contrary, when the stud element is embedded in the plate hole, the wireless communication circuit can be activated by the stud element and be in an unlock state and be driven to generate and send out the locking signal.

59. The quick release mount according to claim 46, wherein, when the stud element is not embedded in the plate hole, the communication circuit is in a broken circuit status and is unable to be driven to generate and send out the locking signal; on the contrary, when the stud element is embedded in the plate hole, the wireless communication circuit can be activated by the stud element and be in an unlock state and be driven to generate and send out the locking signal.

60. The quick release mount according to claim 47, wherein, when the stud element is not embedded in the plate hole, the communication circuit is in a broken circuit status and is unable to be driven to generate and send out the locking signal; on the contrary, when the stud element is embedded in the plate hole, the wireless communication circuit can be activated by the stud element and be in an unlock state and be driven to generate and send out the locking signal.

61. The quick release mount according to claim 48, wherein, when the stud element is not embedded in the plate hole, the communication circuit is in a broken circuit status and is unable to be driven to generate and send out the locking signal; on the contrary, when the stud element is embedded in the plate hole, the wireless communication circuit can be activated by the stud element and be in an unlock state and be driven to generate and send out the locking signal.

62. The quick release mount according to claim 49, wherein, when the stud element is not embedded in the plate hole, the communication circuit is in a broken circuit status and is unable to be driven to generate and send out the locking signal; on the contrary, when the stud element is embedded in the plate hole, the wireless communication circuit can be activated by the stud element and be in an unlock state and be driven to generate and send out the locking signal.

63. The quick release mount according to claim 50, wherein, when the stud element is not embedded in the plate hole, the communication circuit is in a broken circuit status and is unable to be driven to generate and send out the locking signal; on the contrary, when the stud element is embedded in the plate hole, the wireless communication circuit can be activated by the stud element and be in an unlock state and be driven to generate and send out the locking signal.

64. The quick release mount according to claim 51, wherein, when the stud element is not embedded in the plate hole, the communication circuit is in a broken circuit status and is unable to be driven to generate and send out the locking signal; on the contrary, when the stud element is embedded in the plate hole, the wireless communication circuit can be activated by the stud element and be in an unlock state and be driven to generate and send out the locking signal.

65. The quick release mount according to claim 52, wherein, when the stud element is not embedded in the plate hole, the communication circuit is in a broken circuit status and is unable to be driven to generate and send out the locking signal; on the contrary, when the stud element is embedded in the plate hole, the wireless communication circuit can be activated by the stud element and be in an unlock state and be driven to generate and send out the locking signal.
